(19) United States
(12) Patent Application Publication
(10) Pub. No.: US 2012/0315825 A1
(43) Pub. Date: Dec. 13, 2012

(54) DEVICE FOR HOUSING A SUBSTRATE, AND RELATIVE METHOD

(75) Inventors: Andrea Baccini, Mignagola Di Carbonera (IT); Giorgio Cellere, Torri Di Quartesolo (vi) (IT); Luigi De Santi, Spresiano (IT); Marco Galiazzo, Padova (pd) (IT); Gianfranco Pasqualin, Spresiano (IT); Tommaso Vercesi, Treviso (IT)

(73) Assignee: APPLIED MATERIALS, INC., Santa Clara, CA (US)

(21) Appl. No.: 13/394,123

(22) PCT Filed: Sep. 2, 2010
(86) PCT No.: PCT/EP2010/062856

§ 371 Date: May 15, 2012

(30) Foreign Application Priority Data
Sep. 3, 2009 (IT) UD2009A000151

(51) Int. Cl. B24B 41/06; B23Q 3/02; B24B 7/00

(52) U.S. Cl. 451/28; 269/74; 451/391

(57) ABSTRACT

A device for supporting a substrate is provided. The device includes a base body having two or more layers of an insulating material, a substrate support surface formed by the upper layer of the insulating material, one or more cavities formed in a thickness of the base body, and one or more metal elements disposed in the one or more cavities. The substrate support surface of the base body supports the substrate thereon in a processing nest of a printing apparatus. In addition, each metal element comprises one or more features that are used to couple the base body to the processing nest. The metal elements are also provided for magnetically or electromagnetically positioning the base body on a magnetic work plane of a grinding tool. A method is also provided to make the device and attach the device to a planar surface of a processing nest.

### CROSS-REFERENCE TO RELATED APPLICATIONS

This application claims benefit of International Patent Application Ser. No. PCT/EP2010/062856 filed Sep. 2, 2010, which claims the benefit of Italian Patent Application serial number UD2009A000151, filed Sep. 3, 2009, which is herein incorporated by reference.

### FIELD OF THE INVENTION

The present invention concerns a device for housing one or more substrates, for example with a silicon base, known as wafers, to make photovoltaic cells, multilayer printed circuits or, more generally, any electronic circuit. In particular, the device according to the present invention is applied for positioning and moving the substrate between different operating positions, or work stations of a working line, for example a line of silk-screen printing, laser printing, ink jet printing or other.

The present invention also concerns the method to make the device.

### BACKGROUND OF THE INVENTION

It is known that photovoltaic cells substantially consist of a substrate or wafer, generally comprising silicon, on which a plurality of conductor tracks or other metalized or metallization elements are deposited.

In many of the methods for producing electronic circuits, the silicon substrate is positioned on a support surface of a housing device, known as “nest”, which is then attached on relative transport means, so as to move and position the substrate with respect to different processing stations, for example for printing, grinding, edging or other similar process.

The known housing device comprises a plurality of layers of relatively rigid material, for example plastic, attached mechanically, for example by means of screws, on the surface of the transport means.

It is also known that in order to obtain a perfectly flat support surface of the housing device, the surface is first ground and the whole housing device is then fixed on the transport means, with screws.

The tightening of the screws for the mechanical attachment determines a deformation, even if only slight, of the support surface of the housing device. The deformation leads to a loss of the planarity obtained during grinding and may entail an incorrect positioning, or in any case not consistent, of the substrate, with a consequent reduction in the uniform quality of the operations made on the substrate.

It is known that, in order to overcome this problem, it is possible to fix the housing device to the work plane of the machine that does the grinding, using screws that are tightened in the same holes that will then be used to attach the housing device to the transport means.

In this way, the support surface is ground in a condition that simulates the stresses to which it will be subjected, during operating conditions, so as to be flat once installed.

This known technique, however, has relatively long execution times, and consequently increased production costs, due mainly to the need to screw and unscrew the screws so as to simulate, in the grinding step, the operating conditions.

Furthermore, however much the screws used in grinding are tightened and positioned like those used in the operating step, it is not possible to be certain that, during grinding, deformation conditions of the support surface of the housing device are achieved that are equivalent to those that actually occur in the operating step.

Purpose of the present invention is to achieve a housing device, and perfect a production method, that are rapid and economical to carry out, and that guarantee maximum planarity of the support surface even in operating conditions with mechanical attachment to the transport means.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a housing device according to the present invention is applied for positioning and moving a substrate relative to different operating stations, and comprises a base body and at least a support surface, made on the base body and on which the substrate is able to be disposed.

According to a characteristic feature of the present invention, the housing device comprises one or more elements of metal material physically associated with the base body and able to function both as a structural reinforcement for the mechanical attachment of the body to an operating attachment plane, for example by means of screws, and also as a magnetic alignment feature (e.g. fiducial) to define a magnetic cooperation area for the magnetic or electromagnetic positioning of the base body on a magnetic work plane.

Advantageously, in fact, the invention can be used in a fiducials-based alignment method as described, for example, in the Italian patent application UD2009A000119, entirely incorporated here by reference.

Advantageously, the elements of metal material are incorporated with or on the bottom with respect to the thickness of the base body, or in any case under the support surface.

The housing device according to the present invention is less subjected to the deformations due to mechanical attachment, since the mechanical attachment elements used, whether they are screws, tie rods, studs, rivets or other, grip on the elements of metal material, limiting to a minimum the attachment tensions on the base body and therefore the deformations on the support surface.

The housing device according to the present invention, incorporating metal elements, can be retained on a work plane making use of a magnetic field, substantially with the same intensity and the same stresses given by the attachment of traditional holding elements on the metal inserts.

Therefore, a method to produce a housing device according to the present invention provides at least a grinding step in which the base body is positioned and maintained stable magnetically, or electromagnetically, to the work plane and the support surface is ground, so as to define the desired planarity.

In this step, the conditions of positioning and magnetic or electromagnetic stabilization are such as to simulate precisely the conditions of mechanical attachment of the base body to an operating plane.

With the present invention we have the advantage that, with respect to the traditional body, all of plastic, the magnetic or electromagnetic traction carried out during the grinding and that affected mechanically by the screws during the operating step, are applied on the same metal elements. Therefore, during the grinding step the plastic body is subjected to the same mechanical stresses (and the same deformations) to which it will be subjected in operating conditions, and therefore the grinding is very precise.

In particular, in a solution in which an electromagnet is used to generate the electromagnetic attachment action, it is possible to calibrate the electromagnetic force exerted on the metal elements, achieving precisely the conditions of stress which occur with mechanical attachment.

This guarantees that the surface on which the substrate rests remains flat and does not deform during the operating steps, guaranteeing a high uniformity of quality of the work done on the substrate, for example printing steps.

Furthermore, the possibility of attaching the base body to the work plane by means of a magnetic or electromagnetic action also allows to accelerate the grinding steps used to form the support surface, without needing screwing or unscrewing steps, thus improving times and costs of the process, also in the case of batches of substrates having different sizes and/or shapes.

It is in the spirit of the present invention to provide that the metal elements are based on ferromagnetic material.

According to a variant, the metal elements are based on ferromagnetic material; according to another they are made of paramagnetic material.

According to a variant, each metal element comprises one or more holes suitable to insert mechanical attachment elements such as screws for example.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic isometric view of a processing system associated with one embodiment of the present invention;

FIG. 2 is a schematic plan view of the system depicted in FIG. 1;

FIGS. 3A and 3B are schematic isometric views of a processing nest usable in the processing system of FIG. 1;

FIG. 4 is a perspective view of a housing device according to the present invention;

FIG. 5 is a cross section of the device in FIG. 4, in one step of the method;

FIG. 6 is a cross section of the device in FIG. 4, in operative use;

FIG. 7 is a cross section of a first variant of the device in FIG. 4;

FIG. 8 is a front view of a second variant of the device in FIG. 4;

FIG. 9 is a front view of a third variant of the device in FIG. 4.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION OF A PREFERENTIAL FORM OF EMBODIMENT

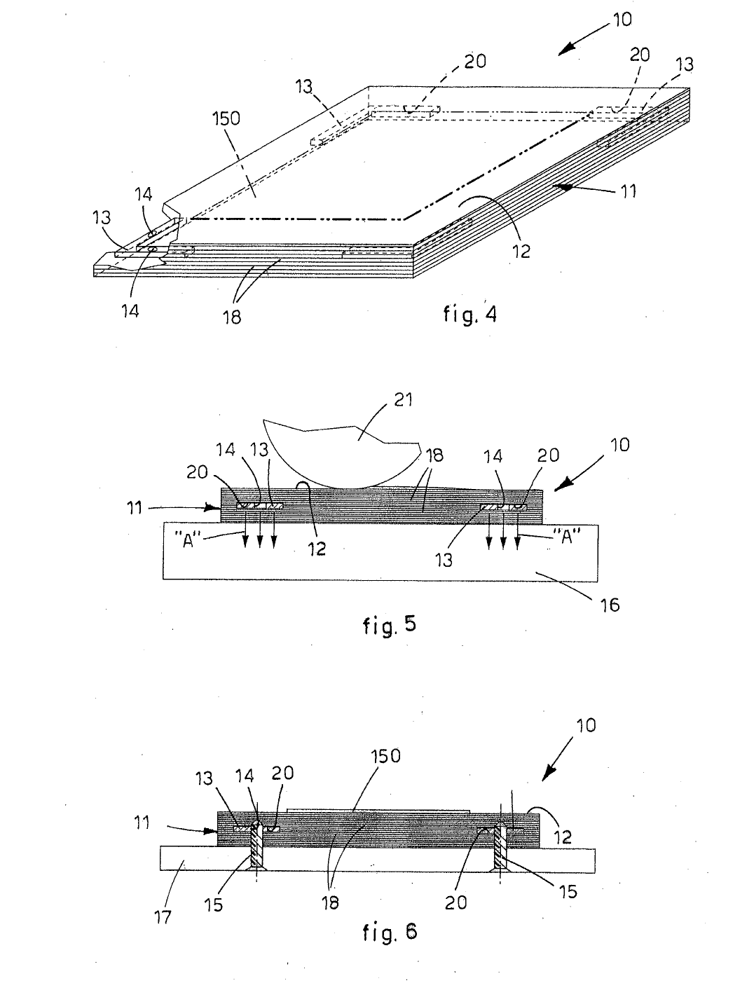

With reference to the attached drawings, embodiments of the present invention relate to a device 10 used for housing one or more substrates, in this case a substrate, or wafer, 150, represented by a line of dashes in FIG. 4, formed from silicon, in one example for making photovoltaic cells. In practice, the device 10 according to the present invention is known as a “nest”.

The device according to the invention can be used, for example, in a work line for the silk-screen printing of print tracks, for example conductive tracks on a substrate, or wafer, 150, to make photovoltaic cells, only partly shown in the drawings.

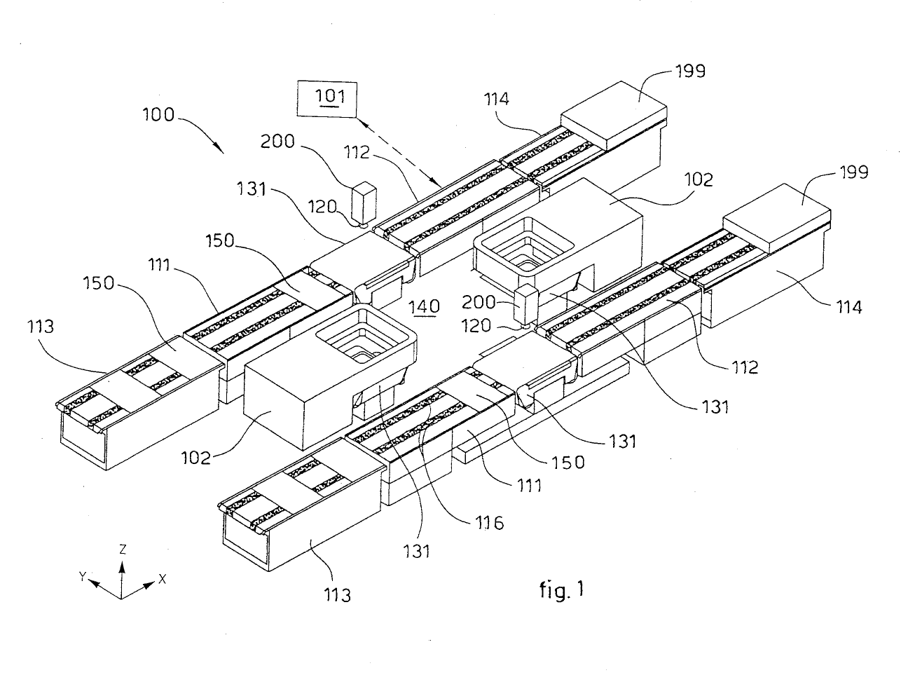

FIG. 1 is a schematic isometric view of a substrate processing system, or system 100, according to one embodiment of the present invention. In one embodiment, the system 100 generally includes two incoming conveyors 111, an actuator assembly 140, a plurality of processing nests 131, a plurality of processing heads 102, two outgoing conveyors 112, and a system controller 101. The incoming conveyors 111 are configured in a parallel processing configuration so that each can receive unprocessed substrates 150 from an input device, such as an input conveyor 113, and transfer each unprocessed substrate, or wafer, 150 to a processing nest 131 coupled to the actuator assembly 140. Additionally, the outgoing conveyors 112 are configured in parallel so that each can receive a processed substrate, or wafer, 150 from a processing nest 131 and transfer each processed substrate, or wafer, 150 to a substrate removal device, such as an exit conveyor 114.

In one embodiment, each exit conveyor 114 is adapted to transport processed substrates 150 through an oven 1509 to cure material deposited on the substrate, or wafer, 150 via the processing heads 102.

In one embodiment of the present invention, the system 100 is a screen printing processing system and the processing heads 102 include screen printing components, which are configured to screen print a patterned layer of material on a substrate, or wafer, 150. In another embodiment, the system 100 is an ink jet printing system and the processing heads 102 include ink jet printing components, which are configured to deposit a patterned layer of material on a substrate, or wafer, 150.

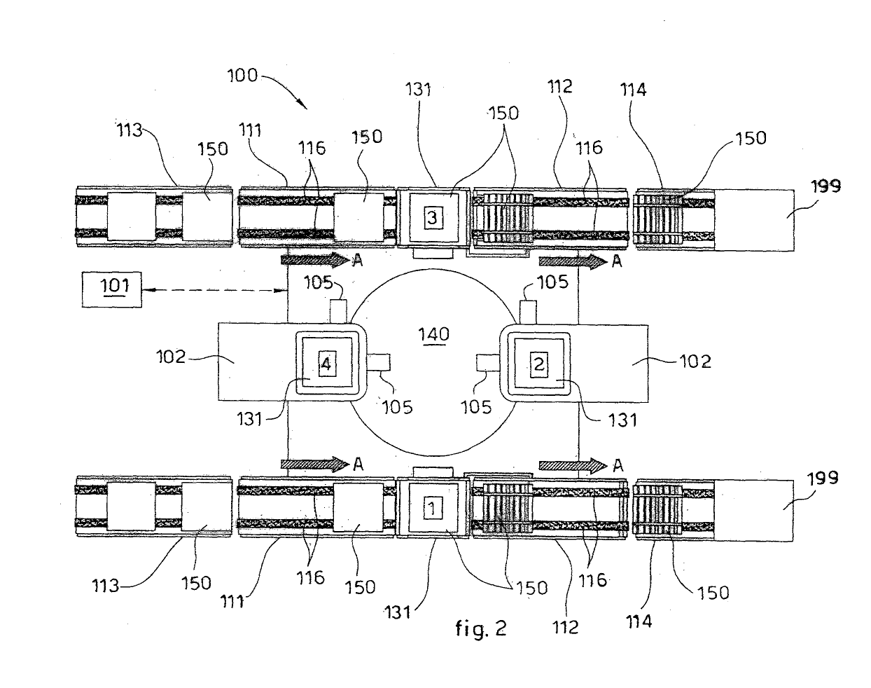

FIG. 2 is a schematic plan view of the system 100 depicted in FIG. 1. FIGS. 1 and 2 illustrate the system 100 having two processing nests 131 (in positions “1” and “3”) each positioned to both transfer a processed substrate, or wafer, 150 to the outgoing conveyor 112 and receive an unprocessed substrate, or wafer, 150 from the incoming conveyor 111. Thus, in the system 100, the substrate motion generally follows the path “A” shown in FIGS. 1 and 2. In this configuration, the other two processing nests 131 (in positions “2” and “4”) are each positioned under a processing head 102 so that a process (e.g., screen printing, ink jet printing, material removal) can be performed on the unprocessed substrates 150 situated on the respective processing nests 131. Such a parallel processing configuration allows increased processing capacity with a minimized processing system footprint. Although, the system 100 is depicted having two processing heads 102 and four processing nests 131, the system 100 may comprise additional processing heads 102 and/or processing nests 131 without departing from the scope of the present invention.

In one embodiment, the incoming conveyor 111 and outgoing conveyor 112 include at least one belt 116 to support and transport the substrates 150 to a desired position within the system 100 by use of an actuator (not shown) that is in communication with the system controller 101. While FIGS. 1 and 2 generally illustrate a two belt style substrate transferring system, other types of transferring mechanisms may be used to perform the same substrate transferring and positioning functions without varying from the basic scope of the invention.

In one embodiment, the system 100 also includes an inspection system 200, which is adapted to locate and inspect the substrates 150 before and after processing has been performed. The inspection system 200 may include one or more cameras 120 that are positioned to inspect a substrate, or wafer, 150 positioned in the loading/unloading positions “1” and “3,” as shown in FIGS. 1 and 2. The inspection system 200 generally includes at least one camera 120 (e.g., CCD camera) and other electronic components that are able to locate, inspect, and communicate the results to the system controller 101. In one embodiment, the inspection system 200 locates the position of certain features of an incoming substrate, or wafer, 150 and communicates the inspection results to the system controller 101 for analysis of the orientation and position of the substrate, or wafer, 150 to assist in the precise positioning of the substrate, or wafer, 150 under a processing head 102 prior to processing the substrate, or wafer, 150. In one embodiment, the inspection system 200 inspects the substrates 150 so that damaged or mis-processed substrates can be removed from the production line. In one embodiment, the processing nests 131 may each contain a lamp, or other similar optical radiation device, to illuminate the substrate, or wafer, 150 positioned thereon so that it can be more easily inspected by the inspection system 200.

The system controller 101 facilitates the control and automation of the overall system 100 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to generate and store at least substrate positional information, the sequence of movement of the various controlled components, substrate inspection system information, and any combination thereof.

In one embodiment, the two processing heads 102 utilized in the system 100 may be conventional screen printing heads available from Applied Materials Italia Srl which are adapted to deposit material in a desired pattern on the surface of a substrate, or wafer, 150 disposed on a processing nest 131 in position “2” or “4” during a screen printing process. In one embodiment, the processing head 102 includes a plurality of actuators, for example, actuators 105 (e.g., stepper motors or servomotors) that are in communication with the system controller 101 and are used to adjust the position and/or angular orientation of a screen printing mask (not shown) disposed within the processing head 102 with respect to the substrate, or wafer, 150 being printed. In one embodiment, the screen printing mask is a metal sheet or plate with a plurality of holes, slots, or other apertures formed therethrough to define a pattern and placement of screen printed material on a surface of a substrate, or wafer, 150. In one embodiment, the screen printed material may comprise a conductive ink or paste, a dielectric ink or paste, a dopant gel, an etch gel, one or more mask materials, or other conductive or dielectric materials. In general, the screen printed pattern that is to be deposited on the surface of a substrate, or wafer, 150 is aligned to the substrate, or wafer, 150 in an automated fashion by orienting the screen printing mask using the actuators 105 and information received by the system controller 101 from the inspection system 200. In one embodiment, the processing heads 102 are adapted to deposit a metal containing or dielectric containing material on a solar cell substrate having a width between about 125 mm and 156 mm and a length between about 70 mm and 156 mm.

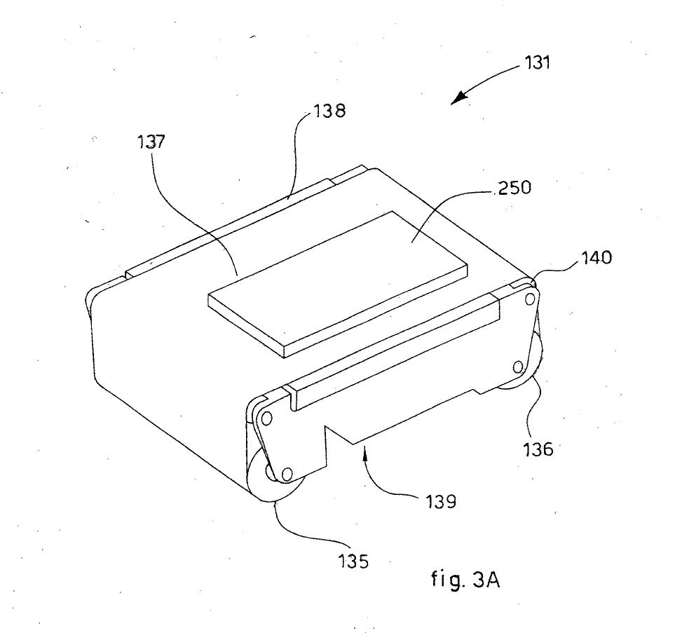

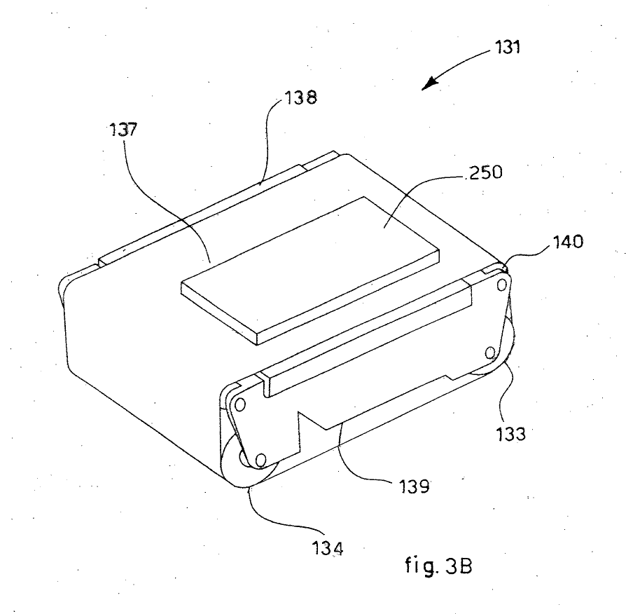

FIGS. 3A-3B are schematic isometric views of processing nests 131 that can be used in the processing system 100. Typically, each processing nest 131 comprises a conveyor 139 that has a feed spool 135 and a take-up spool 136 that are adapted to feed and retain a material 137 positioned across a platen 138 as shown in FIG. 3A. In one embodiment, the material 137 is a porous material that allows a substrate 150 disposed on one side of the material 137 to be held to the platen 138 by a vacuum applied to the opposing side of the material 137 by vacuum ports formed in the platen 138.

In another embodiment, the conveyor 139 is configured as a continuous conveyor system comprising one or more feed rollers 133 and one or more idler rollers 134 for feeding the material 137 positioned across the platen 138 as shown in FIG. 3B. The platen 138 may have a substrate supporting surface on which the substrate 150 and material 137 are supported and retained during the processing performed in the processing head 102. In one embodiment, the material 137 is a porous material that allows a substrate 150 disposed on one side of the material 137 to be held to the platen 138 by a vacuum applied to the opposing side of the material 137 by vacuum ports formed in the platen 138. In one embodiment, the material 137 is cleaned as it is fed by the feed rollers 133 after transferring the substrate 150.

In certain embodiments, the processing nests 131 are always configured in the same orientation when loading and unloading substrates 150. In such embodiments, the continuous conveyor configuration (FIG. 3B) may be preferred over the former conveyor configuration (FIG. 3A) since the former configuration consumes the material 137 as each substrate 150 is loaded and unloaded from the processing nest 131. Thus, in the conveyor configuration in FIG. 3A, the material 137 must be periodically removed and replaced during processing. In contrast, the continuous conveyor configuration (FIG. 3B) does not consume the material 137 during loading and unloading of each substrate 150. Therefore, the continuous conveyor system, as shown in FIG. 3B, may provide cycle time, throughput, and yield benefits in certain embodiments of the present invention.

With particular reference to FIGS. 4, 5 and 6, the device 10 according to the present invention can be used in connection or association with a processing nest 131 as described above and comprises in this case a base body 11 provided on its upper side with a support surface 12, on which the substrate, or wafer, 150 is able to be disposed.

The base body 11 comprises a plurality of layers 18 of insulating material, in this case plastic, made solid substantially overlapping and parallel with each other. The last or highest layer or layers 18 define the support surface 12.

In correspondence with a central portion of the thickness of the base body 11 and in proximity with the corners of the base body 11, each layer 18 comprises four cavities 20, in this case substantially L-shaped.

It is clear that the cavities 20 can have various shapes and sizes and their position inside the base body 11 can vary also according to the shape and sizes of the base body 11, to the positioning zone of the substrate, or wafer, 150 or to other specific operating requirements.

In each cavity 20 an insert 13 is located, with a ferromagnetic or paramagnetic material base, for example iron, nickel, cobalt, or alloys thereof, for example ferritic stainless steels (400 series), or other, also substantially L-shaped.

Alternatively, in each cavity 20 two or more inserts 13 can be located, for example two inserts 13 with a substantially parallelepiped shape, perpendicular to each other.

The inserts 13 are suitable to cooperate, when the device 10 is made, with an electromagnetic work plane 16, for example embedding discrete permanent magnets or comprising an electromagnet, so as to allow a stable positioning of the base body 11 on the work plane 16.

As shown in FIG. 5, the electromagnetic field generated by the work plane 16 generates an electromagnetic traction downward, shown schematically by the arrows “A”, holding to itself the base body 11, during the grinding of the support surface 12. The grinding operation is made with a grinding tool 21, of a substantially known type and only partly shown.

Each insert 13 also comprises one or more threaded through holes 14, which are suitable to allow attachment screws 15 to be screwed in (FIG. 6), to define a mechanical attachment of the base body 11 to an operating attachment plane 17, for example the upper plane of a transport shuttle, such as the processing nest 131 described above.

Advantageously, the screws 15 are inserted into the base body 11 from the bottom upward, perpendicularly, so as not to interfere with the support surface 12 of the substrate, or wafer, 150.

In this way, during the production steps, the electromagnetic traction “A” acts mainly in the zones on which the screws 15 act, that is, in correspondence with the inserts 13, simulating the action of the screws 15 and substantially determining the deformations on the support surface 12 that the screws 15 would determine.

In this way, the action of the grinding tool 21 levels the support surface 12, taking into account the deformations introduced by the traction exerted on the inserts 13 by the screws 15.

In this way, when the base body 11 is then positioned and attached with the screws 15 on the operating plane 17, its support surface 12 has an optimum planarity, guaranteeing a precise and consistent disposition of the substrate, or wafer, 150 and an effective uniformity of quality of the work done on the substrate, or wafer, 150.

It is clear, however, that modifications and/or additions of parts or steps may be made to the device 10 and the method as described heretofore, without departing from the field and scope of the present invention.

For example, it comes within the field of the present invention to provide that, as shown schematically in FIG. 7, the inserts 113 extend substantially over the whole length and/or width of the base body 11.

According to a variant, the inserts 113 are not comprised in the bulk of the base body 11, but are located through between two successive layers 18, so as to divide the base body 11.

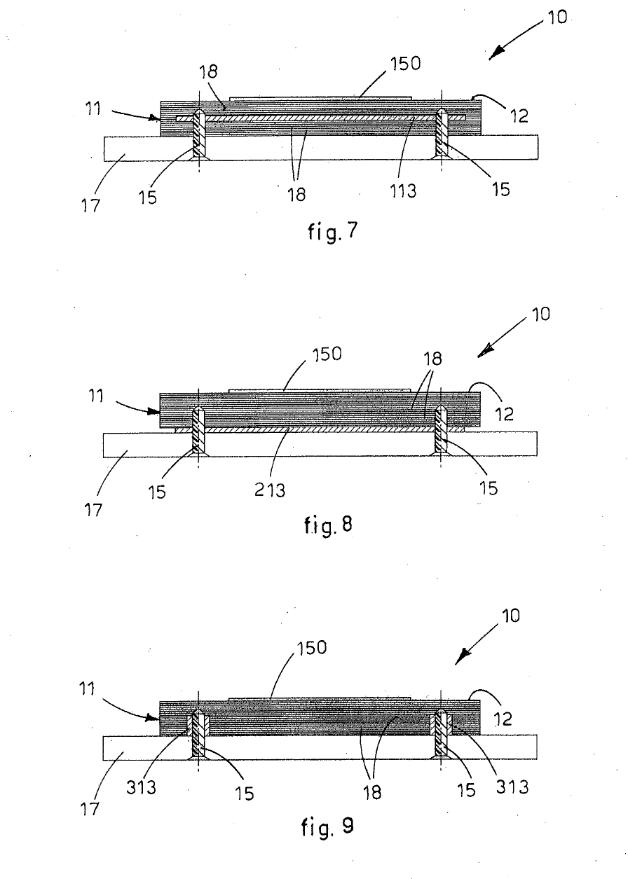

According to the variant shown in FIG. 8, the inserts 213 are attached to the lower layer of the base body 11.

It also comes within the field of the present invention, as shown in FIG. 9, to provide that the inserts 313 are made in the form of elements that can be mechanically coupled with the screws 15. For example, the inserts 313 consist of bushings, female threads, bolts or other similar elements.

It is also clear that, although the present invention has been described with reference to specific examples, a person of skill in the art shall certainly be able to achieve many other equivalent forms of device for housing a substrate, and relative method of production, having the characteristics as set forth in the claims and hence all coming within the field of protection defined thereby.

1-10. (canceled)

11. A device for supporting a substrate, comprising:
a base body comprising:
two or more layers of an insulating material;
a substrate support surface formed by the upper layer of the insulating material, wherein the substrate support surface of the base body supports the substrate thereon in a processing nest of a printing apparatus;
one or more cavities formed in a thickness of the base body; and
one or more metal elements disposed in the one or more cavities, wherein each metal element comprises one or more features that are used to couple the base body to the processing nest.

12. The device of claim 11, wherein
the one or more features of the one or more metal elements comprises holes,
the processing nest comprises one or more mechanical attachment elements, and
the base body is coupled to the processing nest by inserting the one or more mechanical attachment elements into the one or more features of the one or more metal elements.

13. The device of claim 12, wherein the one or more mechanical attachment elements are selected from the group consisting of screws, tie rods, studs, rivets, and combinations thereof.

14. The device of claim 11, wherein the one or more metal elements are at least partly embedded within the thickness of the base body to receive one or more mechanical attachment elements of the processing nest and attach the base body to an operating attachment plane of the processing nest.

15. The device of claim 11, wherein the insulating material comprises a plastic material.

16. The device of claim 11, wherein the metal elements comprises a magnetic material selected from the group consisting of a ferromagnetic material and a paramagnetic material.

17. The device of claim 16, wherein the metal elements are positioned within the two or more layers of the insulating material to allow the metal elements to couple to one or more magnetic elements disposed in the base body on a magnetic work plane of a grinding tool that is used to grind the substrate support surface of the base body.

18. The device of claim 11, wherein the base body is rectangular in shape.

19. The device of claim 11, wherein the base body comprises a plurality of corners and the one or more metal elements are disposed in each of the plurality of the corners of the base body.

20. The device of claim 11, wherein the one or more metal elements are disposed in a central portion of the thickness of the base body.

21. The device of claim 20, wherein the one or more metal elements are L-shaped.

22. The device of claim 11, wherein the base body has a second surface that is opposite to the substrate support surface, wherein the one or more metal elements are disposed within the base body between the substrate support surface and the second surface.

23. The device of claim 11, wherein the base body has a second surface that is opposite to the substrate support surface, wherein the one or more metal elements are disposed in a layer of the two or more layers of an insulating material that is adjacent to the second surface.

24. The device of claim 11, wherein the one or more metal elements have a side that extends substantially through a length or a width of the base body.

25. A method of making a device to be attached to a planar surface of a processing nest, comprising:
retaining a base body of the device to a magnetic work plane of a grinding tool using one or more metal elements disposed within one or more cavities formed in a thickness of the base body, wherein each metal element comprises one or more features that are used to couple the base body to the processing nest; and
removing a material from a surface of the base body to form a planar substrate support surface.

26. The method of claim 25, wherein the base body comprises two or more layers of an insulating material.

27. The method of claim 25, wherein the base body is retained by a magnetic force created between the one or more metal elements and a magnetic field generating device in the grinding tool.

28. The method of claim 25, wherein removing the material from the surface of the base body further comprises grinding the surface until a desired planarity is achieved that is substantially comparable to the planarity of an upper planar surface of the processing nest on which the base body is disposed during a printing process.
